(19) United States
(12) Patent Application Publication
(10) Pub. No.: US 2026/0221102 A1
(43) Pub. Date: Jul. 30, 2026

(54) GATE DRIVER AND DISPLAY APPARATUS INCLUDING THE SAME

(71) Applicant: LG Display Co., Ltd., Seoul (KR)

(72) Inventors: DaHye SHIM, Paju-si (KR); Booheung LEE, Paju-si (KR); HyeonJu TAK, Paju-si (KR)

(73) Assignee: LG Display Co., Ltd., Seoul (KR)

(21) Appl. No.: 19/373,063

(22) Filed: Oct. 29, 2025

(30) Foreign Application Priority Data
Jan. 24, 2025 (KR) 10-2025-0011981

(51) Int. Cl. G09G 3/3266; G09G 3/32

(52) U.S. Cl. CPC G09G 3/3266; G09G 3/32; G09G 2300/0426; G09G 2300/043; G09G 2310/0267; G09G 2330/021; G09G 2330/025

(57) ABSTRACT

A display apparatus includes a display panel including a display area and a non-display area and a gate driver including an emission signal generator distributed and disposed in the display area, wherein the emission signal generator includes a first circuit driven to output an emission signal of a low voltage, a second circuit driven to start an operation of the emission signal generator, a third circuit driven to output a carry signal of a low voltage or a carry signal of a high voltage, and a fourth circuit driven to output an emission signal of a high voltage, and the first to fourth circuits are disposed apart from one another with at least one pixel block therebetween.

### CROSS-REFERENCE TO RELATED APPLICATIONS

This application claims the benefit of the Korean Patent Application No. 10-2025-0011981 filed on January 24, 2025, which is hereby incorporated by reference as if fully set forth herein.

### BACKGROUND

### Technical Field

The present disclosure relates to a gate driver and a display apparatus including the same.

### Description of the Related Art

As information technology advances, the market for display apparatuses which are connection mediums connecting a user with information is growing. Therefore, the use of display apparatuses such as light emitting display apparatuses, quantum dot display (QDD) apparatuses, and liquid crystal display (LCD) apparatuses is increasing.

The display apparatuses described above include a display panel which includes a plurality of subpixels, a driver which outputs a driving signal for driving the display panel, and a power supply which generates power which is to be supplied to the display panel or the driver.

In such display apparatuses, when the driving signal (for example, a scan signal and a data signal) is supplied to each of the subpixels provided in the display panel, a selected subpixel may transmit light or may self-emit light, and thus, an image may be displayed.

### BRIEF SUMMARY

The present disclosure provides a signal generator in which a circuit for outputting an emission signal and a circuit for outputting a carry signal may be separately configured to respectively output the emission signal and the carry signal simultaneously, and thus, may enhance driving stability and driving reliability. Also, the present disclosure may stably output the emission signal and the carry signal without an output error, even when circuits included in the signal generator are distributed and disposed and are also reduced. Also, the present disclosure may reduce the number of signal generators disposed for each circuit board and may decrease a peak-to-peak and a line load occurring when transferring a clock signal, thereby reducing power consumption. Also, the present disclosure may solve a problem where voltage drop occurs when implementing a display panel having a super-sized screen and a high resolution, and based thereon, may enhance the display quality of the display panel.

As embodied and broadly described herein, a display apparatus includes: a display panel including a display area and a non-display area; and a gate driver including an emission signal generator distributed and disposed in the display area, wherein the emission signal generator includes: a first circuit driven to output an emission signal of a low voltage; a second circuit driven to start an operation of the emission signal generator; a third circuit driven to output a carry signal of a low voltage or a carry signal of a high voltage; and a fourth circuit driven to output an emission signal of a high voltage, and the first to fourth circuits are disposed apart from one another with at least one pixel block therebetween.

Each of the first to fourth circuits may be disposed to overlap one pixel block.

The one pixel block may include subpixels coupled to one data line and at least three gate lines included in the display area.

Each of elements included in the first to fourth circuits may be provided one-by-one per one subpixel included in the one pixel block.

The third circuit may include: a stabilization transistor including a gate electrode connected to a second voltage line transferring a second voltage and a first electrode connected to a Q node controlled by the second circuit; a first carry output transistor including a gate electrode connected to a second electrode of the stabilization transistor, a first electrode connected to the second voltage line, and a second electrode connected to a carry output terminal; and a second carry output transistor including a gate electrode controlled by the second circuit and connected to a QB node charged with an electrical potential opposite to an electrical potential of the Q node, a first electrode connected to a first voltage line transferring a first voltage having a level which differs from a level of the second voltage, and a second electrode connected to the carry output terminal.

The third circuit may include a carry capacitor including a first electrode connected to the gate electrode of the first carry output transistor and a second electrode connected to the carry output terminal.

The first circuit and the second circuit may be disposed to overlap subpixels coupled to one data line and three gate lines included in the display area, and the third circuit and the fourth circuit may be disposed to overlap subpixels coupled to one data line and four gate lines included in the display area.

The gate driver may include a plurality of emission signal generators, and the plurality of emission signal generators may have a dependent connection relationship where a carry output terminal of a front end is electrically connected to a start signal line of a rear end.

In another aspect of the present disclosure, a gate driver includes: a first circuit driven to output an emission signal of a low voltage; a second circuit driven to start an operation of an emission signal generator of a display panel; a third circuit driven to output a carry signal of a low voltage or a carry signal of a high voltage; and a fourth circuit driven to output an emission signal of a high voltage, wherein the third circuit includes: a stabilization transistor including a gate electrode connected to a second voltage line transferring a second voltage and a first electrode connected to a Q node controlled by the second circuit; a first carry output transistor including a gate electrode connected to a second electrode of the stabilization transistor, a first electrode connected to the second voltage line, and a second electrode connected to a carry output terminal; and a second carry output transistor including a gate electrode controlled by the second circuit and connected to a QB node charged with an electrical potential opposite to an electrical potential of the Q node, a first electrode connected to a first voltage line transferring a first voltage having a level which differs from a level of the second voltage, and a second electrode connected to the carry output terminal.

The third circuit may include a carry capacitor including a first electrode connected to the gate electrode of the first carry output transistor and a second electrode connected to the carry output terminal.

The present disclosure provides a signal generator in which a circuit for outputting an emission signal and a circuit for outputting a carry signal may be separately configured to respectively output the emission signal and the carry signal simultaneously, and thus, may enhance driving stability and driving reliability. Also, the present disclosure may stably output the emission signal and the carry signal without an output error, even when circuits included in the signal generator are distributed and disposed and are also reduced. Also, the present disclosure may reduce the number of signal generators disposed for each circuit board and may decrease a peak-to-peak and a line load occurring when transferring a clock signal, thereby reducing power consumption. Also, the present disclosure may solve a problem where voltage drop occurs when implementing a display panel having a super-sized screen and a high resolution, and based thereon, may enhance the display quality of the display panel.

### BRIEF DESCRIPTION OF THE SEVERAL VIEWS OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram schematically illustrating a light emitting display apparatus, and FIGS. 2 and 3 are diagrams for describing a gate driver disposed in a display area of a display panel;

FIG. 4 is a first example diagram of a display panel where a gate driver is disposed in a display area, and FIG. 5 is a second example diagram of a display panel where a gate driver is disposed in a display area;

FIG. 6 is an example diagram illustrating a case where the gate driver illustrated in FIG. 3 is disposed in a display area, FIG. 7 is a diagram illustrating a signal transfer characteristic when driving a display panel including a gate driver disposed in a non-display area, and FIG. 8 is a diagram illustrating a signal transfer characteristic when driving a display panel including a gate driver disposed in a display area;

FIG. 9 is a circuit configuration diagram of an emission signal generator according to an embodiment, and FIG. 10 is a driving waveform diagram for showing an operation characteristic of an emission signal generator according to an embodiment;

FIGS. 11 to 13 are diagrams for describing an arrangement example of an emission signal generator according to an embodiment, and FIG. 14 is an example diagram illustrating a stage-based connection relationship of the emission signal generator;

FIGS. 15 to 17 are diagrams for describing advantages obtained when an emission signal generator according to an embodiment is applied to a display panel;

FIG. 18 is a diagram schematically illustrating a power block disposed at a periphery of a circuit block, FIG. 19 is a plan view illustrating in more detail the power block illustrated in FIG. 18, and FIG. 20 is a cross-sectional view of a region A1-A2 of FIG. 19; and

FIG. 21 is an example diagram illustrating a cross-sectional surface of a subpixel included in a pixel block of a display panel.

### DETAILED DESCRIPTION

Hereinafter, the present disclosure will be described more fully with reference to the accompanying drawings, in which example embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

A display apparatus according to the present disclosure may be applied to televisions (TVs), video players, personal computers (PCs), home theaters, electronic devices for vehicles, and smartphones, but is not limited thereto. The display apparatus according to the present disclosure may be implemented as a light emitting display apparatus, a quantum dot display (QDD) apparatus, or a liquid crystal display (LCD) apparatus. Hereinafter, for convenience of description, a light emitting display apparatus self-emitting light by using an inorganic light emitting diode or an organic light emitting diode will be described for example.

Moreover, a transistor described below may be implemented with an n-type transistor, a p-type transistor, or a combination of an n-type transistor and a p-type transistor. A transistor may be a three-electrode element including a gate, a source, and a drain. The source may be an electrode which provides a carrier to a transistor. In the transistor, a carrier may start to flow from the source. The drain may be an electrode where the carrier flows from the transistor to the outside. That is, in the transistor, the carrier flows from the source to the drain.

In the p-type transistor, because a carrier is a hole, a source voltage may be higher than a drain voltage so that the hole flows from the source to the drain. In the p-type transistor, because the hole flows from the source to the drain, a current may flow from the source to the drain. On the other hand, in the n-type transistor, because a carrier is an electron, a source voltage may be lower than a drain voltage so that the electron flows from the source to the drain. In the n-type transistor, because the electron flows from the drain to the source, a current may flow from the drain to the source. However, a source and a drain of a transistor may switch therebetween based on a voltage applied thereto. Based thereon, in the following description, one of a source and a drain will be described as a first electrode, and the other of the source and the drain will be described as a second electrode.

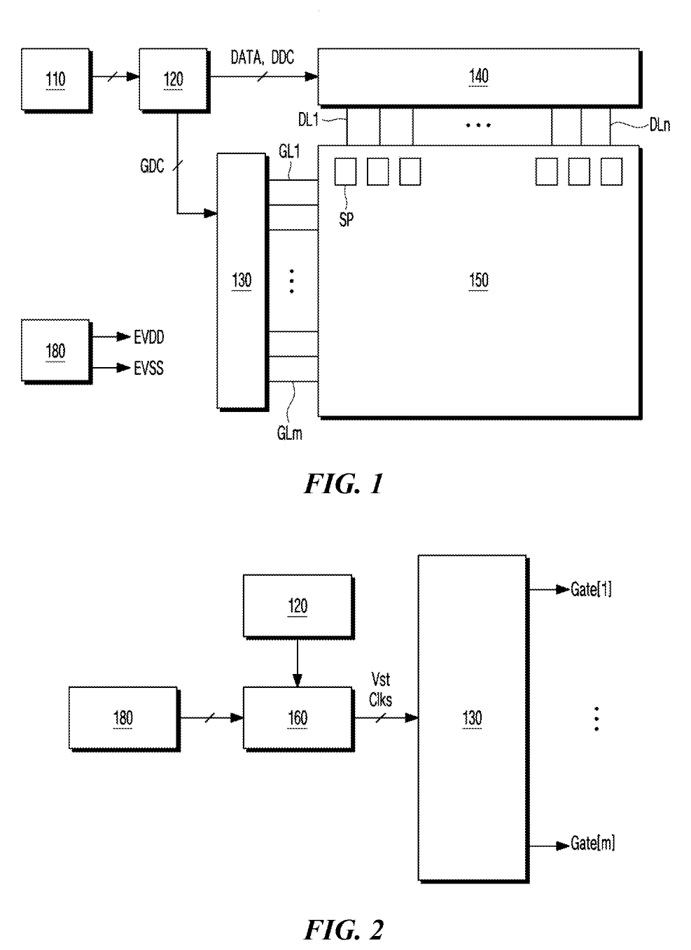

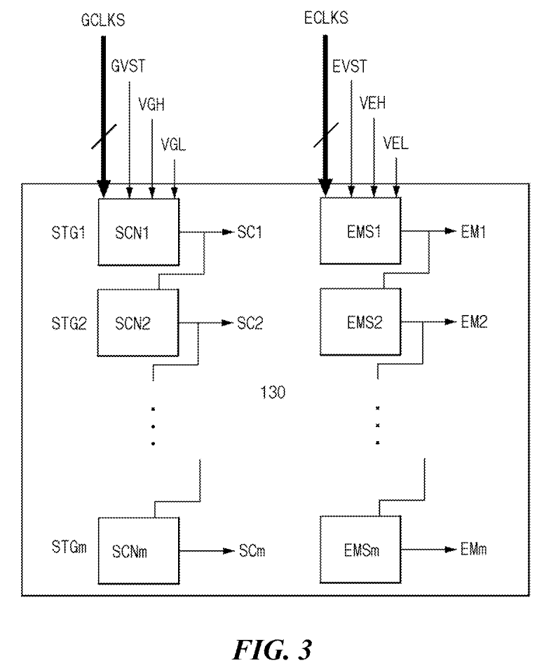

FIG. 1 is a block diagram schematically illustrating a light emitting display apparatus, and FIGS. 2 and 3 are diagrams for describing a gate driver disposed in a display area of a display panel.

As illustrated in FIGS. 1 and 2, a light emitting display apparatus according to an embodiment of the present disclosure may include a timing controller 120, a gate driver 130, a data driver 140, a display panel 150, and a power supply 180.

A video supply unit 110 (a set or a host system) may output a video data signal supplied from the outside or an image data signal stored in an internal memory thereof. The video supply unit 110 may supply a data signal and the various driving signals to the timing controller 120.

The timing controller 120 may output a gate timing control signal GDC for controlling an operation timing of the gate driver 130, a data timing control signal DDC for controlling an operation timing of the data driver 140, and various synchronization signals (a vertical synchronization signal Vsync and a horizontal synchronization signal Hsync). The timing controller 120 may provide the data driver 140 with the data timing control signal DDC and a data signal DATA supplied from the video supply unit 110. The timing controller 120 may be implemented as an integrated circuit (IC) type and may be mounted on a printed circuit board (PCB), but is not limited thereto.

In response to the data timing control signal DDC supplied from the timing controller 120, the data driver 140 may sample and latch the data signal DATA, convert a digital data signal into an analog data voltage, based on a gamma reference voltage, and output the analog data voltage. The data driver 140 may respectively supply data voltages to the subpixels of the display panel 150 through a plurality of data lines DL1 to DLn. The data driver 140 may be implemented as an IC type or may be mounted on the display panel 150 or a PCB, but is not limited thereto.

The power supply 180 may generate a high-level voltage and a low-level voltage, based on an external input voltage supplied from the outside, and may output the high-level voltage and the low-level voltage through a high-level voltage line EVDD and a low-level voltage line EVSS. The power supply 180 may generate and output a voltage needed for driving of the gate driver 130 or a voltage needed for driving of the data driver 140, in addition to the high-level voltage and the low-level voltage.

The display panel 150 may be manufactured based on a substrate, having stiffness or flexibility, such as glass, silicone, or polyimide. The display panel 150 may include a plurality of subpixels SP for displaying an image. The subpixel SP may self-emit light toward an upper surface or the upper substrate and a lower substrate of the display panel 150. The subpixel SP may emit light having one color of red, green, blue, and white. The display panel 150 may display an image, based on a pixel configured with a red subpixel, a green subpixel, and a blue subpixel or a pixel configured with a red subpixel, a green subpixel, a blue subpixel, and a white subpixel.

The gate driver 130 may operate based on signals Vst and Clks and voltages output from the timing controller 120, the power supply 180, and the level shifter 160. The gate driver 130 may output gate signals (or gate voltages) Gate[1] to Gate[m] through gate lines GL1 to GLm connected to the display panel 150 in response to the gate timing control signal GDC supplied from the timing controller 120. The gate driver 130 may include level shifters 130a and 130b for outputting the gate signals Gate[1] to Gate[m].

The level shifters 130a and 130b may each include a plurality of stages STG1 to STGm. The plurality of stages STG1 to STGm may have a dependent connection relationship so as to sequentially output signals. The plurality of stages STG1 to STGm may include a plurality of scan signal generators SCN1 to SCNm for generating scan signals SC1 to SCm and a plurality of emission signal generators EMS1 to EMSm for generating emission signals EM1 to EMm.

The scan signals SC1 to SCm may be used as a signal for controlling a switching transistor so that a data voltage is applied to a capacitor included in a subpixel. The emission signals EM1 to EMm may be used as a signal for controlling an emission control transistor so that a high-level voltage is applied or not applied to a driving transistor included in the subpixel, or may be used as a signal for controlling an emission control transistor so that a driving current generated from the driving transistor is applied or not applied to a light emitting diode. Also, in FIG. 3, the scan signal generators SCN1 to SCNm and the emission signal generators EMS1 to EMSm are illustrated one by one. However, each of the scan signal generators SCN1 to SCNm and the emission signal generators EMS1 to EMSm may be further provided as one or more, based on a driving method and a circuit included in the subpixel.

The emission signal generators EMS1 to EMSm may be connected to first clock signal lines ECLKS which transfer a first clock signal, a first start signal line EVST which transfers a first start signal, a first voltage line VEH which transfers a first voltage, and a second voltage line VEL which transfers a second voltage. The scan signal generators SCN1 to SCNm may be connected to second clock signal lines GCLKS which transfer a second clock signal, a second start signal line GVST which transfers a second start signal, a third voltage line VGH which transfers a third voltage, and a fourth voltage line VGL which transfers a fourth voltage.

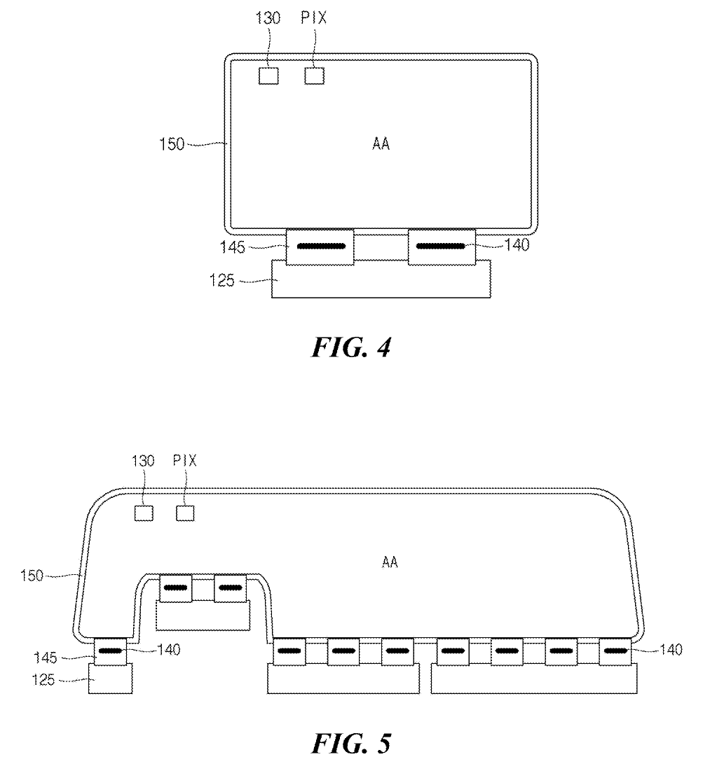

FIG. 4 is a first example diagram of a display panel where a gate driver is disposed in a display area, and FIG. 5 is a second example diagram of a display panel where a gate driver is disposed in a display area.

As illustrated in FIGS. 4 and 5, a display panel 150 may be connected to a first circuit board 145 with a data driver(s) 140 mounted thereon and a second circuit board 125 for implementing a connection with an external device or a timing controller.

The display panel 150 may be implemented to have a rectangular (or circular) shape used for home, office, and commercial use or a non-rectangular (or atypical) shape used for vehicles. In the display panel 150, although a shape differs, circuits configuring a gate driver 130 may be distributed and disposed in a display area AA so as to overlap and be adjacent o a pixel PIX configured with subpixels.

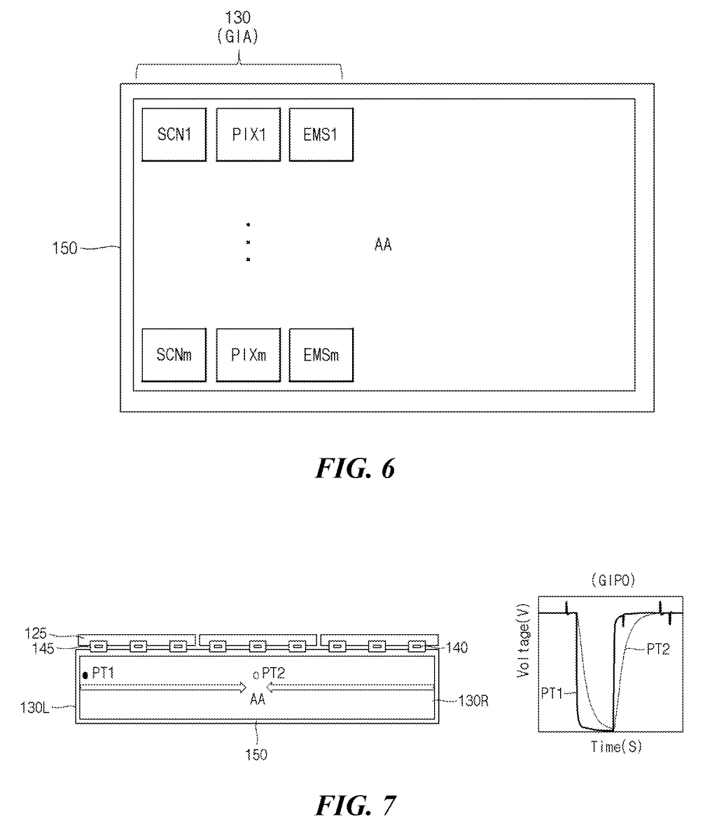

FIG. 6 is an example diagram illustrating a case where the gate driver illustrated in FIG. 3 is disposed in a display area, FIG. 7 is a diagram illustrating a signal transfer characteristic when driving a display panel including a gate driver disposed in a non-display area, and FIG. 8 is a diagram illustrating a signal transfer characteristic when driving a display panel including a gate driver disposed in a display area.

A gate driver 130 configured with elements as described above with reference to FIG. 3 may be disposed in a display area AA of a display panel 150 as illustrated in FIG. 6. A type where scan signal generators SCN1 to SCNm and emission signal generators EMS1 to EMSm included in the gate driver 130 are disposed in a display area AA may be referred to as a gate in array (GIA) type. Furthermore, in FIG. 6, an example is illustrated where the scan signal generators SCN1 to SCNm are disposed on the left of pixels PIX1 to PIXm, and emission signal generators EMS1 to EMSm are disposed on the right of the pixels PIX1 to PIXm, but this may be more for helping understand.

As illustrated in FIG. 7, gate drivers 130L and 130R may be disposed in a non-display area of a display panel 150. A type where the gate drivers 130L and 130R are disposed in the non-display area of the display panel 150 may be referred to as a gate in panel (GIP) type. The GIP type may drive the display panel 150, based on the gate drivers 130L and 130R disposed in a left non-display area and a right non-display area. As seen through a comparison of a first point PT1 adjacent to an outer portion of the display panel 150 and a second point PT2 adjacent to a center thereof, such a type may cause a signal delay phenomenon.

As illustrated in FIG. 8, gate drivers 130A and 130B may be disposed in a display area AA of a display panel 150. A type where the gate drivers 130A and 130B are disposed in the display area AA of the display panel 150 may be referred to as a GIA type. The GIA type may drive the display panel 150, based on the gate drivers 130A and 130B sequentially disposed in the display area AA. As seen through a comparison of output signals GIA0 output from a first point PT1 adjacent to an outer portion of the display panel 150 and a second point PT2 adjacent to a center thereof, a signal delay phenomenon may hardly occur.

Accordingly, the display panel 150 including the gate drivers 130A and 130B of a GIA type may decrease a signal delay phenomenon to solve various problems which occur due to a luminance difference, when implementing a super-sized and/or high-resolution display panel. Also, the display panel 150 including the gate drivers 130A and 130B of a GIA type may realize a narrow bezel.

Hereinafter, an emission signal generator for generating an emission signal will be described as an example of a gate driver of a GIA type according to an embodiment.

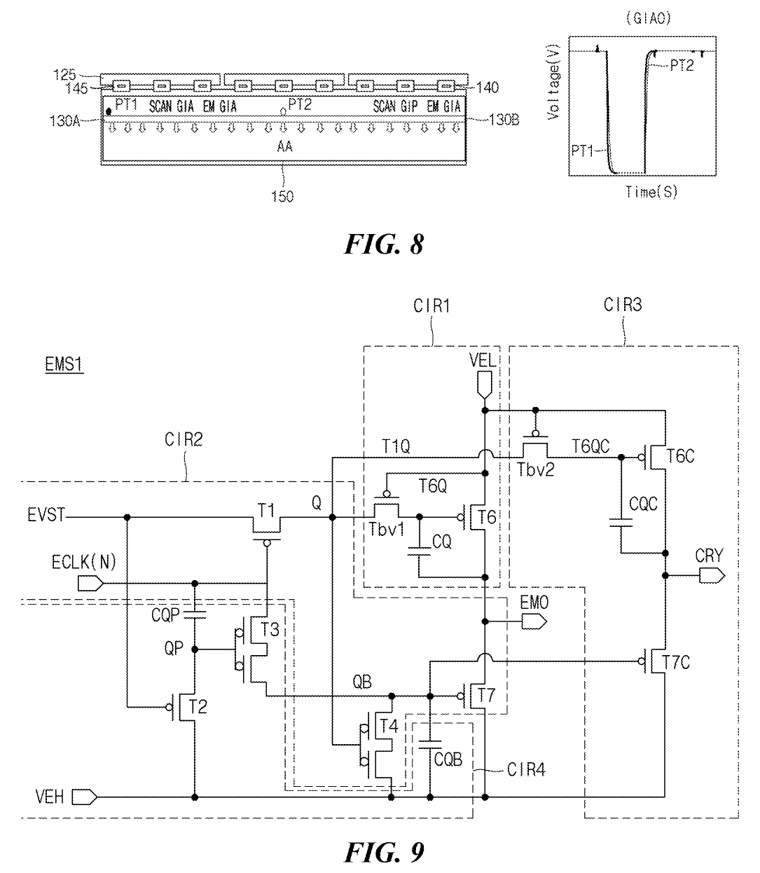

FIG. 9 is a circuit configuration diagram of an emission signal generator according to an embodiment, and FIG. 10 is a driving waveform diagram for showing an operation characteristic of an emission signal generator according to an embodiment.

As illustrated in FIG. 9, an emission signal generator EMS1 according to an embodiment may include a first circuit (or a first emission signal generation circuit) CIR1, a second circuit (or a second emission signal generation circuit) CIR2, a third circuit (or a third emission signal generation circuit) CIR3, and a fourth circuit (or a fourth emission signal generation circuit) CIR4. The first circuit CIR1, the second circuit CIR2, the third circuit CIR3, and the fourth circuit CIR4 may be grouped based on a connection relationship between circuits included in an emission signal generator EMS1 and a harmonious (efficient) arrangement relationship with subpixels.

The first circuit CIR1 may include a circuit which is driven so that an emission signal of a low voltage is output from the emission signal generator EMS1. The first circuit CIR1 may include a first stabilization transistor Tbv1, a first signal output transistor T6, and a first signal capacitor CQ.

The first stabilization transistor Tbv1 may include a gate electrode connected to a second voltage line VEL, a first electrode connected to a first node (or a Q node) T1Q, and a second electrode connected to a second node T6Q. The first stabilization transistor Tbv1 may be turned on based on a second voltage applied through the second voltage line VEL and may allow an electrical potential of the first node T1Q and an electrical potential of the second node T6Q to be stably maintained.

The first signal output transistor T6 may include a gate electrode connected to the second node T6Q, a first electrode connected to the second voltage line VEL, and a second electrode connected to a signal output terminal EMO. The first signal output transistor T6 may be turned on based on an electrical potential of the second node T6Q and may output an emission signal of a low voltage through the signal output terminal EMO, based on a second voltage applied through the second voltage line VEL.

The first signal capacitor CQ may include a first electrode connected to the second node T6Q and a second electrode connected to a signal output terminal EMO. The first signal capacitor CQ may allow the emission signal to be stably output through the signal output terminal EMO.

The second circuit CIR2 may include a circuit which is driven so that an operation of the emission signal generator EMS1 starts. The second circuit CIR2 may include a first node control transistor T1, a second node control transistor T4, and a second signal output transistor T7.

The first node control transistor T1 may include a gate electrode connected to a clock signal line ECLK(N), a first electrode connected to the first start signal line EVST, and a second electrode connected to the first node T1Q. The first node control transistor T1 may be turned on based on a clock signal applied through the clock signal line ECLK(N) and may transfer a first start signal, applied through the first start signal line EVST, to the first node T1Q. The first node T1Q may be charged based on the first start signal of a low voltage applied from the first node control transistor T1 and may be discharged based on the first start signal of a high voltage.

The second node control transistor T4 may include a gate electrode connected to the first node T1Q, a first electrode connected to the first voltage line VEH, and a second electrode connected to a third node (or a QB node) QB. The second node control transistor T4 may be turned on based on an electrical potential of the first node T1Q and may transfer a first voltage, applied through the first voltage line VEH, to the third node QB. The third node QB may be discharged based on the first voltage of a high voltage applied from the second node control transistor T4. Furthermfore, an example where the second node control transistor T4 is configured as a dual transistor for enhancing a capability to cut off a leakage current is illustrated, but the present disclosure is not limited thereto and the second node control transistor T4 may be configured as a single transistor.

The second signal output transistor T7 may include a gate electrode connected to the third node QB, a first electrode connected to the first voltage line VEH, and a second electrode connected to the signal output terminal EMO. The second signal output transistor T7 may be turned on based on an electrical potential of the third node QB and may output the emission signal of a high voltage through the signal output terminal EMO, based on the first voltage applied through the first voltage line VEH.

The third circuit CIR3 may include a circuit which is driven so that a carry signal of a low voltage or a carry signal of a high voltage is output from the emission signal generator EMS1. The third circuit CIR3 may include a second stabilization transistor Tbv2, a first carry output transistor T6C, a carry capacitor CQC, and a second carry output transistor T7C.

The second stabilization transistor Tbv2 may include a gate electrode connected to the second voltage line VEL, a first electrode connected to the first node T1Q, and a second electrode connected to a fourth node T6QC. The second stabilization transistor Tbv2 may be turned on based on the second voltage and may allow an electrical potential of the first node T1Q and an electrical potential of the fourth node T6QC to be stably maintained.

The first carry output transistor T6C may include a gate electrode connected to the fourth node T6QC, a first electrode connected to the second voltage line VEL, and a second electrode connected to a carry output terminal CRY. The first carry output transistor T6C may be turned on based on an electrical potential of the fourth node T6QC and may output the carry signal of a low voltage through the carry output terminal CRY, based on the second voltage.

The carry capacitor CQC may include a first electrode connected to the fourth node T6QC and a second electrode connected to the carry output terminal CRY. The carry capacitor CQC may allow the carry signal to be stably output through the carry output terminal CRY.

The second carry output transistor T7C may include a gate electrode connected to the third node QB, a first electrode connected to the first voltage line VEH, and a second electrode connected to the carry output terminal CRY. The second carry output transistor T7C may be turned on based on an electrical potential of the third node QB and may output the carry signal of a high voltage through the carry output terminal CRY, based on the first voltage applied through the first voltage line VEH.

The fourth circuit CIR4 may include a circuit which is driven so that the emission signal of a high voltage is output from the emission signal generator EMS1. The fourth circuit CIR4 may include a third node control transistor T2, a fourth node control transistor T3, a second scan capacitor CQB, and a stabilization capacitor CQP.

The third node control transistor T2 may include a gate electrode connected to the first start signal line EVST, a first electrode connected to the first voltage line VEH, and a second electrode connected to a fifth node QP. The third node control transistor T2 may be turned on based on the first start signal applied through the first start signal line EVST and may transfer the first voltage, applied through the first voltage line VEH, to the fifth node QP. The fifth node QP may be discharged based on the first voltage of a high voltage applied through the third node control transistor T2.

The fourth node control transistor T3 may include a gate electrode connected to the fifth node QP, a first electrode connected to the clock signal line ECLK(N), and a second electrode connected to the third node QB. The fourth node control transistor T3 may be turned on based on an electrical potential of the fifth node QP and may transfer the clock signal, applied through the clock signal line ECLK(N), to the third node QB. The third node QB may be charged based on the clock signal of a low voltage applied through the fourth node control transistor T3 and may be discharged based on the clock signal of a high voltage. Furthermfore, an example where the third node control transistor T2 is configured as a dual transistor for enhancing a capability to cut off a leakage current is illustrated, but the present disclosure is not limited thereto and the third node control transistor T2 may be configured as a single transistor.

The second scan capacitor CQB may include a first electrode connected to the third node QB and a second electrode connected to the first voltage line VEH. The second scan capacitor CQB may allow the emission signal to be stably output through the signal output terminal EMO.

The stabilization capacitor CQP may include a first electrode connected to the clock signal line ECLK(N) and a second electrode connected to the fifth node QP. The stabilization capacitor CQP may allow the fifth node QP to be put in a state where the fifth node QP is not floated and is electrically stabilized.

As illustrated in FIGS. 9 and 10, the emission signal generator EMS1 according to an embodiment may have an operation characteristic of receiving the first start signal Vst applied through the first start signal line EVST in response to a falling edge of the clock signal Eclk. Therefore, the clock signal Eclk, an emission signal Emo, and a carry signal Cry may have the same phase. An electrical potential T1q of a first node, an electrical potential T6q of a second node, and an electrical potential T6qc of a fourth node, which are included in the emission signal generator EMS1, may have phases which are equal or similar to one another. Also, an electrical potential Qb of a third node may operate to be opposite to the nodes described above and may have an opposite phase, and an electrical potential Qp of a fifth node may have a phase which is the same as or similar to that of the clock signal.

The emission signal generator EMS1 according to an embodiment may perform a turn-on operation and a turn-off operation of the first node control transistor T1, based on the clock signal Eclk which is generated to alternately have a low voltage or a high voltage. Also, the electrical potential T1q of the first node, the electrical potential T6q of the second node, and the electrical potential T6qc of the fourth node may be referred to as the first start signal Vst of a high voltage, which is applied when performing a turn-on operation of the first node control transistor T1. Also, the electrical potential Qb of the third node may be referred to as a low voltage opposite thereto.

In this case, the second signal output transistor T7 and the second carry output transistor T7C may be turned on. As the second signal output transistor T7 and the second carry output transistor T7C are turned on, the emission signal Emo and the carry signal Cry may be output as the first voltage (a high voltage) applied through the first voltage line VEH.

Subsequently, the electrical potential Qb of the third node may be shifted to a high voltage, and the electrical potential T1q of the first node, the electrical potential T6q of the second node, and the electrical potential T6qc of the fourth node may be shifted to a low voltage. In this case, the second signal output transistor T7 and the second carry output transistor T7C may be turned off, and the first signal output transistor T6 and the first carry output transistor T6C may be turned on. As the first signal output transistor T6 and the first carry output transistor T6C are turned on, the emission signal Emo and the carry signal Cry may be output as the second voltage (a low voltage) applied through the second voltage line VEL.

As described above, the emission signal generator EMS1 according to an embodiment may be configured with a circuit which outputs the emission signal Emo and a circuit which outputs the carry signal Cry, but may separately and simultaneously output the same output, thereby enhancing driving stability and driving reliability. Accordingly, although circuits are distributed and disposed and may be reduced, the emission signal generator EMS1 according to an embodiment may stably output the emission signal Emo and the carry signal Cry of a high voltage or a low voltage without an output error.

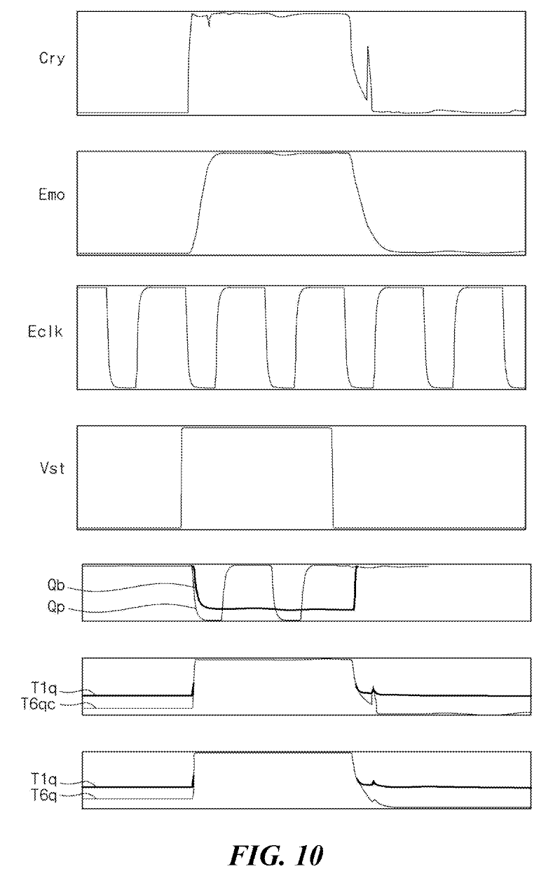

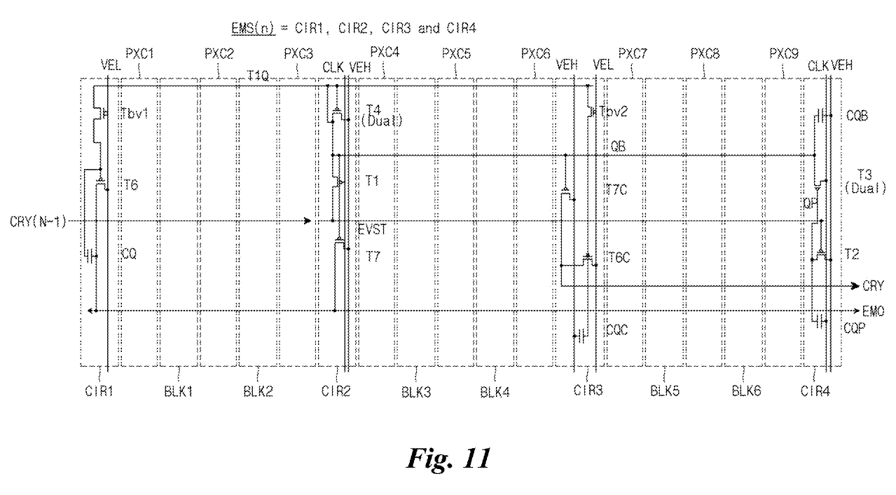

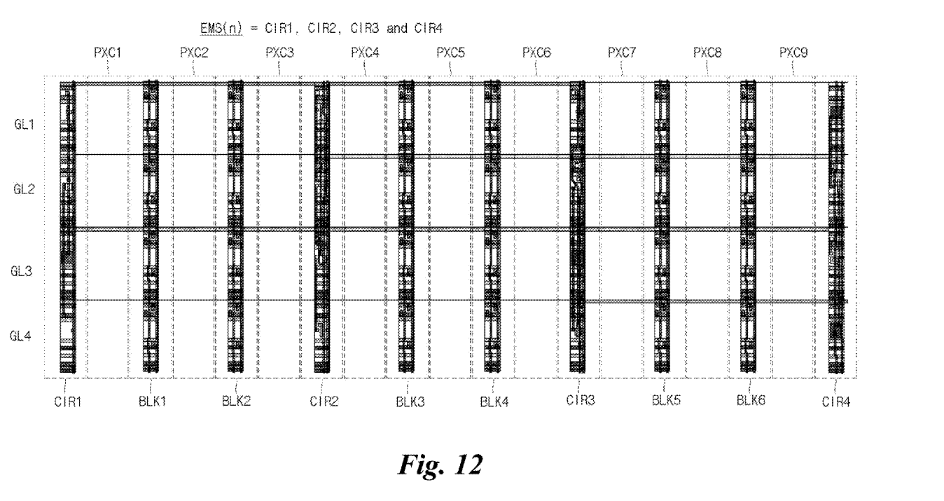

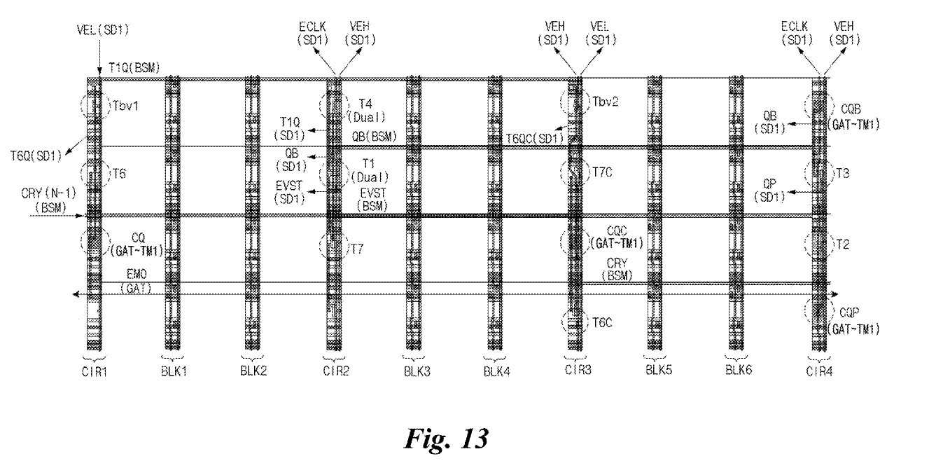

FIGS. 11 to 13 are diagrams for describing an arrangement example of an emission signal generator according to an embodiment, and FIG. 14 is an example diagram illustrating a stage-based connection relationship of the emission signal generator. Here, FIG. 12 is a layout illustrating a state where first to fourth circuits CIR1 to CIR4 and first to sixth power blocks BLK1 to BLK6 illustrated in FIG. 11 are actually implemented in a display panel. Also, FIG. 13 is a diagram where FIGS. 11 and 12 are coupled to each other, so as to describe an arrangement state of the first to fourth circuits CIR1 to CIR4 illustrated in FIG. 11. FIGS. 11 and 12 separately illustrate a real layout and a configuration of a circuit, so as to help understand an element-based arrangement relationship.

As illustrated in FIGS. 9, 11, and 12, according to an embodiment, first to fourth circuits CIR1 to CIR4 included in an emission signal generator EMS1 may be disposed apart from one another with two pixel blocks therebetween. A first pixel block BLK1 and a second pixel block BLK2 may be disposed between the first circuit CIR1 and the second circuit CIR2, a third pixel block BLK3 and a fourth pixel block BLK4 may be disposed between the second circuit CIR2 and the third circuit CIR3, and a fifth pixel block BLK5 and a sixth pixel block BLK6 may be disposed between the third circuit CIR5 and the sixth circuit CIR6.

The first circuit CIR1 may be disposed on the left of the first pixel block BLK1, and the second circuit CIR2 may be disposed on the right of the second pixel block BLK2 adjacent to the first pixel block BLK1. The third circuit CIR3 may be disposed on the right of the fourth pixel block BLK4 adjacent to the third pixel block BLK3 disposed on the right of the second circuit CIR2, and the fourth circuit CIR4 may be disposed on the right of the sixth pixel block BLK6 adjacent to the fifth pixel block BLK5 disposed on the right of the third circuit CIR3.

As illustrated in FIGS. 9, 11, and 12, according to an embodiment, the first to fourth circuits CIR1 to CIR4 included in the emission signal generator EMS1 may be arranged in a vertical direction of a display panel. The first to fourth circuits CIR1 to CIR4 included in the emission signal generator EMS1 may be disposed apart from one another with two power blocks and three pixel blocks, arranged in the vertical direction, therebetween.

For example, the first pixel block BLK1, a first power block PXC1, the second pixel block BLK2, a second power block PXC2, and the third pixel block BLK3 may be disposed in order between the first circuit CIR1 and the second circuit CIR2, the fourth pixel block BLK4, a third power block PXC3, the fifth pixel block BLK5, a fourth power block PXC4, and the sixth pixel block BLK6 may be disposed in order between the second circuit CIR2 and the third circuit CIR3, and a seventh pixel block BLK7, a fifth power block PXC5, an eighth pixel block BLK8, a sixth power block PXC6, and a ninth pixel block BLK9 may be disposed in order between the third circuit CIR3 and the fourth circuit CIR4.

In the embodiments described above, for convenience of description and easiness of distinguishment, an example is illustrated and has been described where the first to fourth circuits CIR1 to CIR4 included in the emission signal generator EMS1 are arranged in the vertical direction of the display panel and are disposed apart from one another with three pixel blocks and two power blocks therebetween. However, the first to fourth circuits CIR1 to CIR4 included in the emission signal generator EMS1 may be disposed apart from one another with at least one pixel block and power block therebetween, for efficient space use and arrangement optimization.

Moreover, in the embodiments described above, for convenience of description and easiness of distinguishment, an example is illustrated and has been described where the first to fourth circuits CIR1 to CIR4 included in the emission signal generator EMS1 are arranged in the vertical direction of the display panel and occupy four gate lines including first to fourth gate lines GL1 to GL4. However, the first to fourth circuits CIR1 to CIR4 included in the emission signal generator EMS1 may be disposed to occupy at least two gate lines, based on an arrangement type and configurations of circuits, but the present disclosure is not limited thereto.

Furthermore, according to the embodiment, one pixel block may be referred to as a total of four subpixels arranged in the vertical direction, and two power blocks may be referred to as a high-level voltage line and a low-level voltage line. However, this may be modified based on an arrangement relationship and configurations of the first to fourth circuits CIR1 to CIR4 included in the emission signal generator EMS1, but the present disclosure is not limited thereto.

Hereinafter, an arrangement relationship between elements included in each circuit will be described in more detail, and an example will be described where first to fourth circuits CIR1 to CIR4 are arranged in a vertical direction of a display panel and occupy four gate lines.

As illustrated in FIGS. 11 to 13, a first circuit CIR1 may include a first stabilization transistor Tbv1, a first signal output transistor T6, and a first signal capacitor CQ. The elements included in the first circuit CIR1 may be arranged in the following order.

First, the first stabilization transistor Tbv1 may be disposed in a subpixel area coupled to a first gate line GL1. Subsequently, the first signal output transistor T6 may be disposed in a subpixel area coupled to a second gate line GL2. Subsequently, the first signal capacitor CQ may be disposed in a subpixel area coupled to a third gate line GL3.

The first circuit CIR1 may include a second node T6Q and a second voltage line VEL. The second node T6Q and the second voltage line VEL may be formed by a first source drain metal layer SD1. The first signal capacitor CQ may be formed by a gate metal layer GAT and a dummy metal layer TM1 disposed thereon. A signal output terminal EMO may be formed by the gate metal layer GAT. However, this may be merely one embodiment, and the present disclosure is not limited thereto. Also, an arrow illustrated in a horizontal direction in FIGS. 11 and 13 may denote that an emission signal output through the signal output terminal EMO may be applied to pixel blocks horizontally adjacent to each other in common.

The second circuit CIR2 may include a second node control transistor T4, a first node control transistor T1, and a second signal control transistor T7. The elements included in the second circuit CIR2 may be arranged in the following order.

First, the second node control transistor T4 may be disposed in a subpixel area coupled to the first gate line GL1. Subsequently, the first node control transistor T1 may be disposed in a subpixel area coupled to the second gate line GL2. Subsequently, the second node control transistor T7 may be disposed in a subpixel area coupled to the third gate line GL1.

The second circuit CIR2 may include a clock signal line ECLK, a first start signal line EVST, a first voltage line VEH, a first node T1Q, and a third node QB. The clock signal line ECLK, the first start signal line EVST, the first voltage line VEH, the first node T1Q, and the third node QB may be formed by a first source drain metal layer SD1. A portion, extending for an electrical connection between the third circuit CIR3 and the fourth circuit CIR4, of each of the third node QB and the first start signal line EVST of the second circuit CIR2 may be formed by a shield layer BSM disposed in a lowermost layer on a substrate. However, this may be merely one embodiment, but the present disclosure is not limited thereto.

Furthermore, the second node control transistor T4 may be implemented as a single transistor, or may be configured as a dual transistor as in FIG. 9. Also, the first node control transistor T1 may also be configured as a dual transistor. The third circuit CIR3 may include a second stabilization transistor Tbv2, a second carry output transistor T7C, a first carry output transistor T6C, and a carry capacitor CQC. The elements included in the third circuit CIR3 may be arranged in the following order.

First, the second stabilization transistor Tbv2 may be disposed in the subpixel area coupled to the first gate line GL1. Subsequently, the second carry output transistor T7C may be disposed in the subpixel area coupled to the second gate line GL2. Subsequently, the first carry output transistor T6C may be disposed in the subpixel area coupled to the third gate line GL3. Subsequently, the carry capacitor CQC may be disposed in a subpixel area coupled to a fourth gate line GL4.

The third circuit CIR3 may include a first voltage line VEH, a second voltage line VEL, and a fourth node T6QC. The first voltage line VEH, the second voltage line VEL, and the fourth node T6QC may be formed by the first source drain metal layer SD1. The carry capacitor CQC may be formed by the gate metal layer GAT and the dummy metal layer TM1 disposed thereon. In the third circuit CIR3, a carry output terminal CRY may be formed by the shield layer BSM disposed in the lowermost layer on the substrate, and this may be like a carry output terminal CRY (N-1) of a front end also. However, this may be merely one embodiment, but the present disclosure is not limited thereto.

The fourth circuit CIR4 may include a second scan capacitor CQB, a fourth node control transistor T3, a third node control transistor T2, and a stabilization capacitor CQP. The elements included in the fourth circuit CIR4 may be arranged in the following order.

First, the second scan capacitor CQB may be disposed in the subpixel area coupled to the first gate line GL1. Subsequently, the fourth node control transistor T3 may be disposed in the subpixel area coupled to the second gate line GL2. Subsequently, the third node control transistor T2 may be disposed in the subpixel area coupled to the third gate line GL3. Subsequently, the stabilization capacitor CQP may be disposed in the subpixel area coupled to the fourth gate line GL4.

The fourth circuit CIR3 may include a clock signal line ECLK, a first voltage line VEH, a third node QB, and a fifth node QP. The clock signal line ECLK, the first voltage line VEH, the third node QB, and the fifth node QP may be formed by the first source drain metal layer SD1. The stabilization capacitor CQP may be formed by the gate metal layer GAT and the dummy metal layer TM1 disposed thereon. However, this may be merely one embodiment, but the present disclosure is not limited thereto. Also, the third node control transistor T3 may be implemented as a single transistor, or may be configured as a dual transistor as in FIG. 9.

According to an embodiment, the third node QB may be disposed in a gate line direction in a non-display area between the first gate line GL1 and the second gate line GL2 so as to be connected to the elements included in the second to fourth circuits CIR2 to CIR4. The first start signal line EVST may be disposed in the gate line direction in a non-display area between the second gate line GL2 and the third gate line GL3 so as to be connected to the elements included in the second circuit CIR2 and the fourth circuit CIR4. The carry output terminal CRY and the signal output terminal EMO may be disposed in the gate line direction in a non-display area between the third gate line GL3 and the fourth gate line GL4. The other elements which are not described may be disposed to be connected to each other in the same block, and thus, a connection relationship thereof may refer to FIG. 9 or 11.

As illustrated in FIG. 14, emission signal generators EMS(n) to EMS(n+3) may have a stage-based dependent connection relationship. A first start signal line EVST of an N^{th} emission signal generator EMS(n) may be connected to a carry output terminal CRY(n-1) of an N^{th}-1 emission signal generator (not shown) disposed in a front end. A first start signal line EVST of an N^{th}+1 emission signal generator EMS(n+1) may be connected to a carry output terminal CRY(n) of the N^{th} emission signal generator EMS(n) disposed in a front end. A first start signal line EVST of an N^{th}+2 emission signal generator EMS(n+2) may be connected to a carry output terminal CRY(n+1) of the N^{th}+1 emission signal generator EMS(n+1) disposed in a front end. A first start signal line EVST of an N^{th}+3 emission signal generator EMS(n+3) may be connected to a carry output terminal CRY(n+2) of the N^{th}+2 emission signal generator EMS(n+2) disposed in a front end.

Accordingly, the emission signal generators EMS(n) to EMS(n+3) may have a dependent connection relationship where a carry output terminal of a front end is electrically connected to a first start signal line of a rear end.

To have the connection relationship described above, the emission signal generators EMS(n) to EMS(n+3) may all be disposed apart from one another on different gate lines. For example, an example is illustrated where the N^{th}+1 emission signal generator EMS(n+1) is disposed more downward from at least one gate line than the N^{th} emission signal generator EMS(n), the N^{th}+2 emission signal generator EMS(n+2) is disposed more downward from at least one gate line than the N^{th}+1 emission signal generator EMS(n+1), and the N^{th}+3 emission signal generator EMS(n+3) is disposed more downward from at least one gate line than the N^{th}+2 emission signal generator EMS(n+2). However, this may be merely one embodiment, the emission signal generators EMS(n) to EMS(n+3) may all be disposed apart from one another on the same gate line.

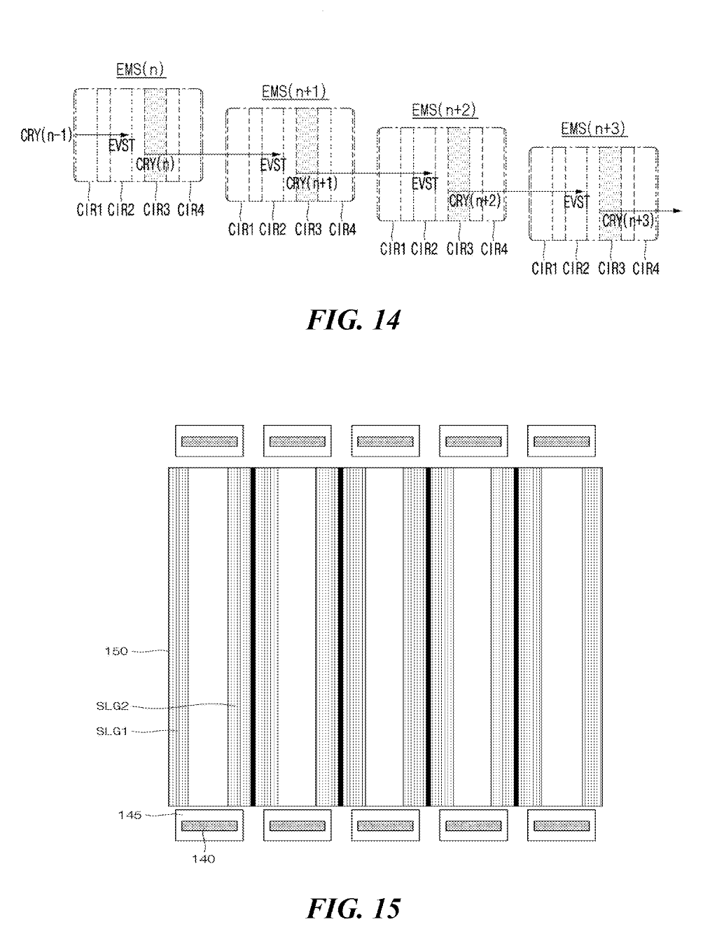

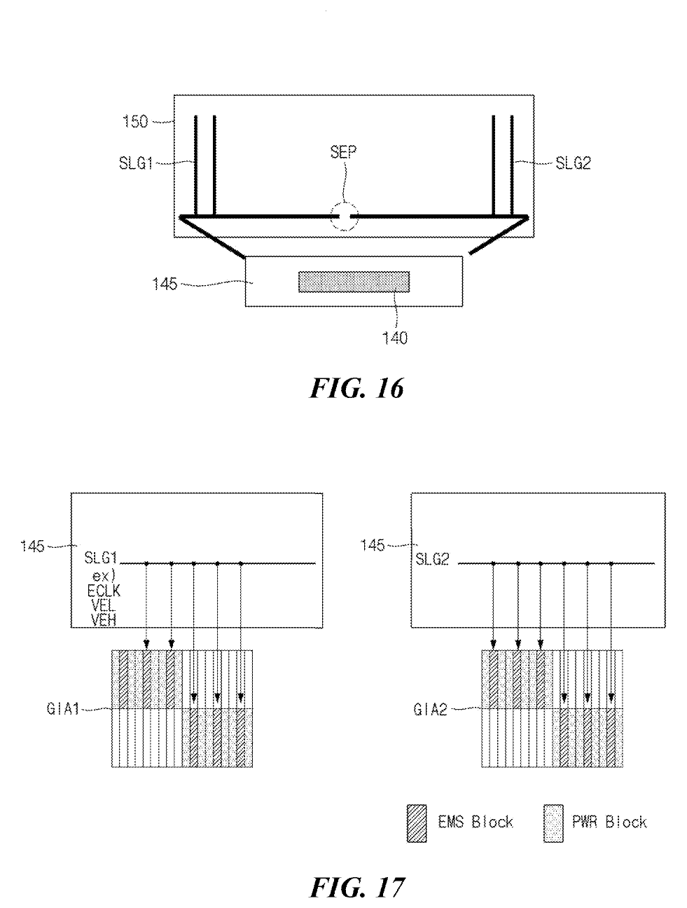

FIGS. 15 to 17 are diagrams for describing advantages obtained when an emission signal generator according to an embodiment is applied to a display panel.

As illustrated in FIG. 15, a plurality of first circuit boards 145 and a plurality of data drivers 140 may be needed when implementing a super-sized and/or high-resolution display panel 150.

As illustrated in FIGS. 15 to 17, when an emission signal generator according to an embodiment is applied to the display panel 150 in a GIA type, one emission signal generator (for example, GIA1 or GIA2) may be disposed to be allocated per one first circuit board 145. In FIG. 17, emission signal generators may be referred to by “GIA1 and GIA2,” so as to represent that the emission signal generators are formed on the display panel 150 in a GIA type.

The emission signal generators GIA1 and GIA2 on the display panel 150 may be separately connected to signal lines SLG1 and SLG2 disposed on the first circuit board 145. For example, the first emission signal generator GIA1 may be connected to a first signal line SLG1, and the second emission signal generator GIA2 may be connected to a second signal line SLG2. The first signal line SLG1 and the second signal line SLG2, for example, may include a clock signal line ELCK, a first voltage line VEH, and a second voltage line VEL and may have a structure separated by a separation portion SEP, but are not limited thereto.

As described above, as the number of emission signal generators disposed per circuit board is reduced, a line load and a peak-to-peak occurring when transferring a clock signal may be reduced, and thus, power consumption may decrease. The reason may be because the clock signal is applied in a pulse form, and the peak-to-peak is formed by +30 V or more (the line load and the peak-to-peak increase as the number of arranged emission signal generators increases), and thus, as the number of arranged emission signal generators is reduced to solve a corresponding problem.

Referring to FIG. 17, the emission signal generators GIA1 to GIA4 on the display panel 150 may have a structure where a power block (PWR Block) is disposed between circuit blocks (EMS Block), and elements relevant thereto will be described below in more detail.

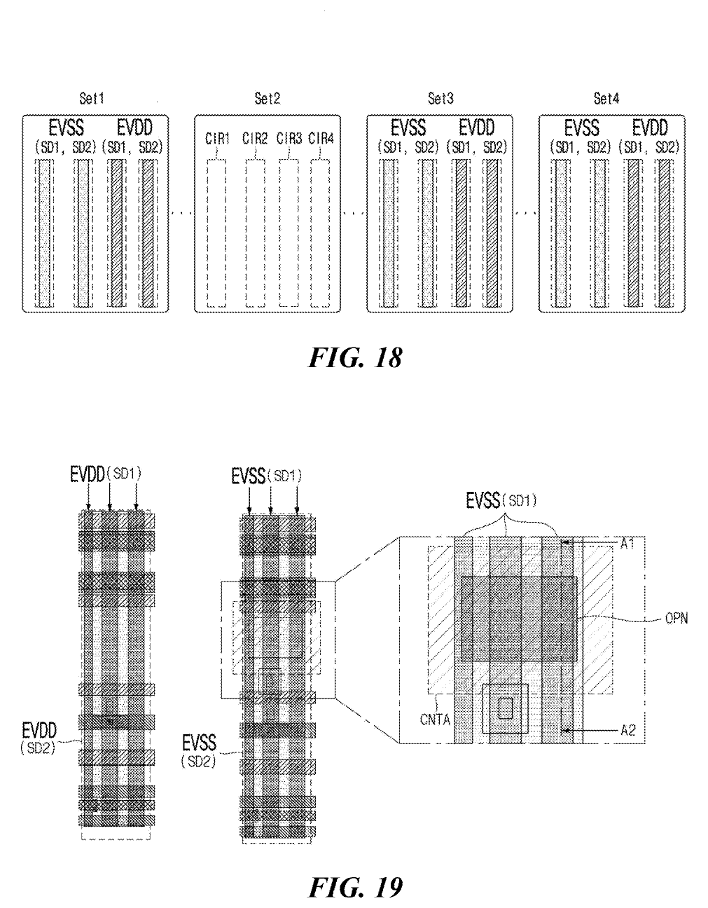

FIG. 18 is a diagram schematically illustrating a power block disposed at a periphery of a circuit block, FIG. 19 is a plan view illustrating in more detail the power block illustrated in FIGS. 18, and 20, is a cross-sectional view of a region A1-A2 of FIG. 19.

As illustrated in FIG. 18, when emission signal generators CIR1 to CIR4 according to an embodiment are applied to a display panel in a GIA type, a second set Set2 where the emission signal generators CIR1 to CIR4 are disposed may provide a space where power blocks Set1, Set3, and Set4 may be disposed at a left side and a right side.

The power blocks Set1, Set3, and Set4 may include a high-level voltage line EVDD and a low-level voltage line EVSS. The high-level voltage line EVDD and the low-level voltage line EVSS may include a first source drain metal layer SD1 and a second source drain metal layer SD2 disposed thereon.

The power blocks Set1, Set3, and Set4 may provide a reinforcement configuration and structure for improving the voltage drop (or IR drop) of at least one of the high-level voltage line EVDD and the low-level voltage line EVSS disposed in the display panel. Hereinafter, a configuration and a structure of the low-level voltage line EVSS will be described for example. For convenience of description, a structure of a lower layer such as the first source drain metal layer SD1 used for configuring a data line disposed in the display panel may be omitted, and a structure of a middle layer and a structure of an upper layer will be described.

As illustrated in FIGS. 19 and 20, the low-level voltage line EVSS may include a second source drain metal layer SD2, an anode electrode layer AND, and a cathode electrode layer CAT. The second source drain metal layer SD2 may be disposed on a first planarization layer PLN1 formed on a substrate SUB. The anode electrode layer AND may be disposed on a third planarization layer PLN3 formed on a second planarization layer PLN2 covering the second source drain metal layer SD2. The cathode electrode layer CAT may be disposed on an emission layer EML formed on a bank layer BNK covering a portion of the anode electrode layer AND.

The low-level voltage line EVSS may correspond to a middle layer, the second source drain metal layer SD2 disposed on the first planarization layer PLN1 may correspond to an upper layer, and the low-level voltage line EVSS may include the anode electrode layer AND disposed on the third planarization layer PLN3. As described above, the low-level voltage line EVSS may have a multi-layer structure, and voltage drop may occur in a center region of the display panel, when implementing a super-sized and/or high-resolution display panel.

To solve such a problem, the low-level voltage line EVSS according to an embodiment may include an opening region OPN exposing a portion of the anode electrode layer AND and a contact region CNTA where an electrical connection between the cathode electrode layer CAT and the anode electrode layer AND which is a different electrode layer is formed. That is, the cathode electrode layer CAT electrically connected to the anode electrode layer AND may be an auxiliary electrode layer or a reinforcement layer of the low-level voltage line EVSS. Here, as an example may be described where the opening region OPN may be formed based on a laser drilling process, and then, an electrical connection between the cathode electrode layer CAT and the anode electrode layer AND may be formed by depositing the cathode electrode layer CAT, but the present disclosure is not limited thereto.

Furthermore, the second source drain metal layer SD2 may be formed of the same material in the same layer as a metal layer used for configuring a transistor disposed in the display panel, and the anode electrode layer AND and the cathode electrode layer CAT may be formed of the same material in the same layer as an electrode layer used for configuring a light emitting diode disposed in the display panel. Accordingly, the layers included in the low-level voltage line EVSS may be referred to as the second source drain metal layer SD2, the anode electrode layer AND, and the cathode electrode layer CAT, and the elements may be electrically disconnected from the transistor and the light emitting diode.

As described above, in a case where a voltage line is configured to further include the cathode electrode layer CAT electrically connected to the anode electrode layer AND, a problem of voltage drop of the voltage line may be solved based on a reduction in line resistance, and based thereon, the display quality of the display panel may be enhanced. Also, power consumption may decrease based on the configuration.

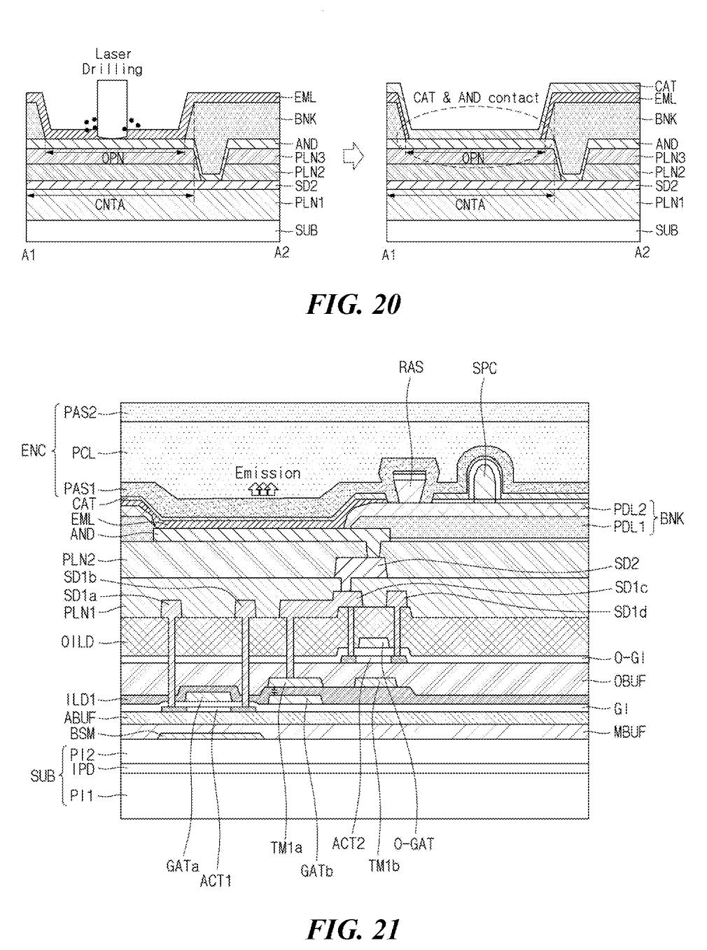

FIG. 21 is an example diagram illustrating a cross-sectional surface of a subpixel included in a pixel block of a display panel.

As illustrated in FIG. 21, a subpixel included in a pixel block may include thin-film layers disposed between a substrate SUB and an encapsulation layer ENC, and a layered structure thereof will be described below.

The substrate SUB may include a first substrate layer PI1, a second substrate layer IPD, and a third substrate layer PI2. The first substrate layer PI1 and the third substrate layer PI2 may be selected as an organic layer including polyimide, and the second substrate layer IPD disposed between the first substrate layer PI1 and the third substrate layer PI2 may be selected as an inorganic layer including oxide silicone (SiO₂).

A shield layer BSM may be disposed on the substrate SUB. A first buffer layer MBUF may be disposed on the shield layer BSM. A second buffer layer ABUF may be disposed on the first buffer layer MBUF. A first semiconductor layer ACT1 of a switching transistor may be disposed on the second buffer layer ABUF. A first gate insulation layer GI may be disposed on the first semiconductor layer ACT1. A 1A^{th} gate metal layer GATa which is a gate electrode of the switching transistor and a 1B^{th} gate metal layer GATb which is a lower electrode of a capacitor may be disposed on the first gate insulation layer GI.

A first interlayer insulation layer ILD1 may be disposed on the 1A^{th} gate metal layer GATa and the 1B^{th} gate metal layer GATb. A 1A^{th} dummy metal layer TM1a which is an upper electrode of the capacitor and a 1B^{th} dummy metal layer TM1b which is a shield layer of a driving transistor may be disposed on the first interlayer insulation layer ILD1. A third buffer layer OBUF may be disposed on the 1A^{th} dummy metal layer TM1a and the 1B^{th} dummy metal layer TM1b. A second semiconductor layer ACT2 of the driving transistor may be disposed on the third buffer layer OBUF.

A second gate insulation layer O-GI may be disposed on the second semiconductor layer ACT2 of the driving transistor. A second interlayer insulation layer OILD may be disposed on the second gate insulation layer O-GI. A first electrode layer SD1a and a second electrode layer SD1b connected to a drain region and a source region of the first semiconductor layer ACT1 of the switching transistor and a first electrode layer SD1c and a second electrode layer SD1d connected to a drain region and a source region of the second semiconductor layer ACT2 of the driving transistor may be separately disposed on the second interlayer insulation layer OILD. The first electrode layer SD1a and the second electrode layer SD1b of the switching transistor and the first electrode layer SD1c and the second electrode layer SD1d of the driving transistor may be formed by a first source drain metal layer.

A first planarization layer PLN1 may be disposed on the first electrode layer SD1a and the second electrode layer SD1b of the switching transistor and the first electrode layer SD1c and the second electrode layer SD1d of the driving transistor. A connection electrode layer SD2 connected to the first electrode layer SD1c of the driving transistor may be disposed on the first planarization layer PLN1. The connection electrode layer SD2 may be formed by a second source drain metal layer. A second planarization layer PLN2 may be disposed on the connection electrode layer SD2.

An anode electrode layer AND may be disposed on the second planarization layer PLN2. The anode electrode layer AND may be divided on the second planarization layer PLN2 and may be an element for exposing a portion of the second planarization layer PLN2, and a bank layer BNK including a first division layer PDL1 and a second division layer PDL2 may be disposed. The bank layer BNK may include a first partition wall RAS having a reverse tapered shape and a second partition wall SPC having a tapered shape (or an embossing shape), but at least one of the elements may be omitted. An emission layer EML may be disposed on the anode electrode layer AND. A cathode electrode layer CAT may be disposed on the emission layer EML.

An upper substrate ENC including a lower layer PAS1, a middle layer PCL, and an upper layer PAS2 may be disposed on the cathode electrode layer CAT. Also, a touch screen layer which receives, as an input, a touch by a finger from a user may be further disposed on the upper substrate ENC. Furthermore, a light emitting diode including the anode electrode layer AND, the emission layer EML, and the cathode electrode layer CAT may emit light toward an upper portion where the upper substrate ENC is disposed, but the present disclosure is not limited thereto.

Hereinabove, the present disclosure provides a signal generator in which a circuit for outputting an emission signal and a circuit for outputting a carry signal may be separately configured to respectively output the emission signal and the carry signal simultaneously, and thus, may enhance driving stability and driving reliability. Also, the present disclosure may stably output the emission signal and the carry signal without an output error, even when circuits included in the signal generator are distributed and disposed and are also reduced. Also, the present disclosure may reduce the number of signal generators disposed for each circuit board and may decrease a peak-to- peak and a line load occurring when transferring a clock signal, thereby reducing power consumption. Also, the present disclosure may solve a problem where voltage drop occurs when implementing a display panel having a super-sized screen and a high resolution, and based thereon, may enhance the display quality of the display panel.

While the present disclosure has been particularly shown and described with reference to example embodiments thereof, it will be understood by those of ordinary skill in the art that various changes in form and details may be made therein without departing from the spirit and scope of the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display apparatus comprising:
a display panel including a display area and a non-display area; and
a gate driver including an emission signal generator distributed and disposed in the display area,
wherein the emission signal generator comprises:
a first circuit configured to output an emission signal of a low voltage;
a second circuit configured to start an operation of the emission signal generator;
a third circuit configured to output a carry signal of a low voltage or a carry signal of a high voltage; and
a fourth circuit configured to output an emission signal of a high voltage, and
the first, second, third, and fourth circuits are disposed apart from one another with at least one pixel block therebetween.

2. The display apparatus of claim 1, wherein each of the first, second, third, and fourth circuits is disposed to overlap one pixel block.

3. The display apparatus of claim 2, wherein the one pixel block comprises subpixels connected to one data line and at least three gate lines included in the display area.

4. The display apparatus of claim 2, wherein each of elements included in the first, second, third, and fourth circuits is provided one-by-one per one subpixel included in the one pixel block.

5. The display apparatus of claim 1, wherein the third circuit comprises:
a stabilization transistor including a gate electrode connected to a second voltage line for transferring a second voltage and a first electrode connected to a Q node connected to be controlled by the second circuit;
a first carry output transistor including a gate electrode connected to a second electrode of the stabilization transistor, a first electrode connected to the second voltage line, and a second electrode connected to a carry output terminal; and
a second carry output transistor including a gate electrode connected to be controlled by the second circuit and connected to a QB node connected to be charged with an electrical potential opposite to an electrical potential of the Q node, a first electrode connected to a first voltage line for transferring a first voltage having a level which differs from a level of the second voltage, and a second electrode connected to the carry output terminal.

6. The display apparatus of claim 5, wherein the third circuit comprises a carry capacitor including a first electrode connected to the gate electrode of the first carry output transistor and a second electrode connected to the carry output terminal.

7. The display apparatus of claim 1, wherein the first circuit and the second circuit overlap subpixels connected to one data line and three gate lines included in the display area, and
the third circuit and the fourth circuit overlap subpixels connected to one data line and four gate lines included in the display area.

8. The display apparatus of claim 1, wherein the gate driver comprises a plurality of emission signal generators, and
the plurality of emission signal generators have a cascade connection relationship where a carry output terminal of a front end is electrically connected to a start signal line of a rear end.

9. A gate driver comprising:
a first circuit configured to output an emission signal of a low voltage;
a second circuit configured to start an operation of an emission signal generator of a display panel;
a third circuit driven configured to output a carry signal of a low voltage or a carry signal of a high voltage; and
a fourth circuit configured to output an emission signal of a high voltage,
wherein the third circuit comprises:
a stabilization transistor including a gate electrode connected to a second voltage line for transferring a second voltage and a first electrode connected to a Q node connected to be controlled by the second circuit;
a first carry output transistor including a gate electrode connected to a second electrode of the stabilization transistor, a first electrode connected to the second voltage line, and a second electrode connected to a carry output terminal; and
a second carry output transistor including a gate electrode connected to be controlled by the second circuit and connected to a QB node connected to be charged with an electrical potential opposite to an electrical potential of the Q node, a first electrode connected to a first voltage line for transferring a first voltage having a level which differs from a level of the second voltage, and a second electrode connected to the carry output terminal.

10. The gate driver of claim 9, wherein the third circuit comprises a carry capacitor including a first electrode connected to the gate electrode of the first carry output transistor and a second electrode connected to the carry output terminal.

11. A gate driver of a display device, comprising:
a first output terminal configured to output an emission signal;
a second output terminal configured to output a carry signal, the second output terminal separate from the first output terminal;
first circuitry connected to the first output terminal; and
second circuitry connected to the second output terminal,
wherein the first circuitry includes:
a first transistor connected between a first power terminal and the first output terminal;
a first stabilization transistor connected between a Q node and a gate terminal of the first transistor, a gate of the first stabilization transistor connected to the first power terminal; and
a first capacitor connected between the gate terminal of the first transistor and the first output terminal; and
wherein the second circuitry includes:
a second transistor connected between the first power terminal and the second output terminal;
a second stabilization transistor connected between the Q node and a gate terminal of the second transistor, a gate of the second stabilization transistor connected to the first power terminal; and
a second capacitor connected between the gate terminal of the second transistor and the second output terminal.

12. The gate driver of claim 11, wherein the first circuitry includes a third transistor connected between the first output terminal and a second power terminal, a gate of the third transistor connected to a QB node, the QB node configured to have a logic level opposite to a logic level of the Q node.

13. The gate driver of claim 12, wherein the first circuitry includes a third capacitor connected between a gate of the third transistor and the second power terminal.

14. The gate driver of claim 13, wherein the second circuitry includes a fourth transistor connected between the second output terminal and the second power terminal, a gate of the fourth transistor connected to the QB node.

15. The gate driver of claim 14, wherein the third capacitor is connected between a gate of the fourth transistor and the second power terminal.

16. The gate driver of claim 11, comprising a fifth transistor connected between the QB node and the second power terminal, a gate of the fifth transistor connected to the Q node.

17. The gate driver of claim 11, comprising a sixth transistor connected between the Q node and a start signal terminal, a gate of the sixth transistor connected to a clock signal terminal.

18. The gate driver of claim 17, comprising a seventh transistor and an eighth transistor,
the seventh transistor connected between the QB node and the clock signal terminal, a gate of the seventh transistor connected to a QP node,
the eighth transistor connected between the QP node and the second power terminal, a gate of the eighth transistor connected to the start signal terminal.

19. The gate driver of claim 18, comprising a third capacitor connected between the QP node and the clock signal terminal.

20. The gate driver of claim 11, wherein the first circuitry and the second circuitry are disposed in a display area of the display device.
